(19) United States
(12) Patent Application Publication
(10) Pub. No.: US 2012/0045031 A1
(43) Pub. Date: Feb. 23, 2012

(54) METHOD FOR SPECTROMETRY FOR INVESTIGATING SAMPLES CONTAINING AT LEAST TWO ELEMENTS

(75) Inventors: Peter Malmqvist, Enkoping (SE); Conny Holm, Vasteras (SE); Martin Nilsson, Uppsala (SE); Johan Malmqvist, Skelleftea (SE); Lars Brandt, Orsundsbro (SE)

(73) Assignee: MULTISCAT AB, Orsundsbro (SE)

(21) Appl. No.: 13/144,104

(22) PCT Filed: Jan. 14, 2010
(86) PCT No.: PCT/SE10/50036

§ 371 Date: Oct. 20, 2011

(30) Foreign Application Priority Data
Jan. 19, 2009 (SE) 0900051-4

(51) Int. Cl. G01N 23/223

(52) U.S. Cl. 378/45

(57) ABSTRACT

A sample with unknown concentrations of elements is placed in a first step into a spectrometer and the intensities I1, I2, . . . , In of the sample for the component elements are measured while the concentrations of the sample are determined, or—alternatively—a sample with known concentrations of the substances C1, C2, . . . , Cn is placed into the spectrometer and the intensities of the sample are determined. The fictive theoretical intensity values, the I_{100%}-values, for the component elements are calculated in a second step with the aid of the determined concentrations and the measured intensities I1, I2, . . . , In, or with the aid of the determined intensities and the known concentrations C1, C2, . . . Cn. New I_{100%}-values for the corresponding elements are calculated in a third step with the aid of standards with known concentrations, the intensities of which standards are measured. The fictive theoretical I_{100%}-values, for the case in which the concentrations have been determined, are adjusted in a fourth step with the aid of the calculated fictive I_{100%}-values multiplied by the ratio for the concentration determined to the concentration of the standard and multiplied by the ratio for the known intensity of the standard to the measured intensity, and, for the case in which the intensities have been determined, the calculated fictive I_{100%}-value multiplied by the ratio of the known concentration to the concentration of the standard and multiplied by the ratio for the intensity of the standard to the determined intensity. A sample with unknown concentrations of the elements is placed in a fifth step into the spectrometer and the intensities of the various elements are read off.

A calibration procedure for X-ray fluorescence analysis using a single sample is described in the Swedish patent 529 264.

Present X-ray spectrometers are highly developed machines with many facilities, designed to facilitate not only the setting of instrument parameters but also the recording of measurements. The work of calibration of the instrument that is to be used is a time-consuming and important part of the work in any chemical analytical process. This is the case for, for example, setting of the instrument parameters used, monitoring settings that have been carried out or, in other words, the operational reliability of the instrument used, and not least the work for validation of the chemical-analytical method that has been developed, together with its documentation. The said work can be significantly simplified with the suggested method and the procedure for this will be presented below, in a simple case in which X-ray fluorescence analysis has been used.

All chemical-analytical methods are based on the fact that a physical-chemical property of an element is to be characterised through the measurement of this property, or to be determined in some other way. Furthermore, it is required in nearly all cases that also a background value must be determined, the cause of which background is often unknown. In other words, it will be necessary to determine at least two properties (two points) when calibrating one element. This is also the case when determining the concentration of a standard, which is used for the validation of an analytical method.

Thus, calibration is normally carried out by the use of one or several samples for each element with the subsequent determination/measurement of the background for the element in question.

A previous article by the inventor: “Application of J. E. Fernandez algorithms in the evaluation of X-ray intensities measured on fused glass discs for a set of international standards and a proposed calibration procedure”, J Malmqvist; X-RAY SPECTROMETRY; X-Ray Spectrom 2001; 30:83-92, has described a method by which it is possible to carry out a calibration for an element with the aid of a glass standard containing a “highly purified” chemical. Thus, in the said case, one standard is required for each element that is to be calibrated. This article is incorporated herewith as part of the present application.

The patent described above concerns a method for spectrometry for the investigation of samples in which the sample contains at least two elements. The invention according to the patent is characterised in that a sample with known concentrations of known elements is placed in a first step in a spectrometer and the intensities I1, I2, . . . , In of the sample for the various component elements are measured, in that known concentrations C1, C2, . . . , Cn for the component elements are related in a second step to the measured intensities I1, I2, . . . , In, such that a fictive intensity for a 100% pure sample of element of each of the elements can be calculated, in that calibration constants K1, K2, . . . , Kn for each of the elements are calculated in a third step as the ratio between the measured intensity I1, I2, . . . , In and the calculated intensity for the relevant 100% pure element, in that a sample with unknown concentrations of the said elements is placed in a fourth step into the spectrometer and the intensities of the various elements are read, and in that the concentration of the relevant element is calculated in a fifth step in last mentioned sample as the measured intensity multiplied by the relevant calibration constant for the elements that are components of the sample.

One disadvantage of the method described in the patent is that it is necessary to begin with a sample that has known concentrations of the component elements. This means that it is necessary to produce a sample in order to use it as a starting sample, and this production may be both time-consuming and expensive.

The present invention solves this problem.

The present invention thus relates to a method for spectrometry for the investigation of samples, where the sample contains at least two elements and it is characterised by the combination of a number of steps, namely that a sample with unknown concentrations of the elements is placed in a first step into a spectrometer and the intensities I1, I2, . . . , In of the sample for the component elements are measured while the concentrations of the sample are determined, or—alternatively—that a sample with known concentrations of the substances C1, C2, . . . , Cn is placed into the spectrometer and the intensities of the sample are determined, in that the fictive theoretical intensity values, the I_{100%}-values, for the component elements are calculated in a second step with the aid of the determined concentrations and the measured intensities I1, I2, . . . , In, or with the aid of determined intensities and known concentrations C1, C2,. . . Cn, in that new I_{100%}-values for the corresponding said elements are calculated in a third step with the aid of standards with known concentrations, the intensities of which standards are measured, in that the fictive theoretical I_{100%}-values, for the case in which the concentrations have been determined, are adjusted in a fourth step with the aid of the calculated fictive I_{100%}-value multiplied by the ratio for the concentration determined to the concentration of the standard and multiplied by the ratio for the known intensity of the standard to the measured intensity, and, for the case in which the intensities have been determined, the calculated fictive I_{100%}-value multiplied by the ratio of the known concentration to the concentration of the standard and multiplied by the ratio for the intensity of the standard to the determined intensity, in that a sample with unknown concentrations of the said elements is placed in a fifth step into the spectrometer and the intensities of the various elements are read off.

The unique characteristic of the method according to the patent named above is that only a single sample containing the elements that are to be calibrated is required to carry out a calibration for two or more elements.

The method is based on, in addition to the known concentrations of the elements in the single manufactured sample, the ability to calculate at the same time also the background from only a single measurement of this sample, i.e. only one measurement for each element, i.e. one point.

The unique characteristic of the present invention is that either a sample with unknown concentrations of elements is placed in the first step in a spectrometer and the intensities I1, I2, . . . , In of the sample are measured for the various component elements and that the concentrations of the sample are determined, or—alternatively—that a sample with known concentrations of the substances C1, C2, . . . , Cn is placed into the spectrometer and the intensities of the sample are determined. The intensities and the concentrations can be determined by inputting these into a computer that is used to carry out calculations according to claim 1, and subsequently in a later step the I_{100%}-values of the intensities of the substances are adjusted by comparison with standards of known concentrations, such as certified reference material (CRM) standards. It is in this way not necessary to produce a sample in order to use it as a starting point.

For at least certain types of material, such as stainless steel, tool steel, etc., and also non-steel materials, the intensity varies in a similar manner within the type of material at different concentrations of the component substances. A computer file can be created in such circumstances containing the intensities for a particular type of material. Such a computer file can be used to determine intensities according to the description given above.

A method has been developed in one computer program entitled the MultiScat programme, which is used and which is based on the said algorithms of J. E. Fernández, in order to calculate the calibration constant for the relevant elements in the sample. This is carried out using the calculated concentrations and the measured, or determined, intensities or concentrations for the sample, after which new calibration constants are calculated. The concentrations of the two 100% samples are then calculated by the use of these calibration constants.

According to one preferred embodiment, the calculation takes place according to the second step described above through the use of a correlation between the concentration of an element and the intensity that the said concentration gives rise to in the spectrometer that is used.

According to one preferred design of the previously mentioned preferred embodiment, the calculation takes place in the said second step, where the said known concentrations C1, C2, . . . , Cn for the component elements are related to the measured intensities I1, I2, . . . , In such that a fictive intensity for a 100% pure element for each one of the elements is calculated, using algorithms described in the article: “Application of J. E. Fernandez algorithms in the evaluation of X-ray intensities measured on fused glass discs for a set of international standards and a proposed calibration procedure”, J Malmqvist; X-RAY SPECTROMETRY; X-Ray Spectrom 2001; 30:83-92.

A sample with unknown concentrations of known elements is placed in the first step described above into a spectrometer of suitable known type and the intensities I1, I2, . . . , In of the sample for the various component elements are measured.

Alternatively, a sample with known concentrations of known elements is placed into a spectrometer of suitable known type and the intensities I1, I2, . . . , In of the sample for the various component elements are determined.

In the second step described above, the fictive theoretical intensity values, the I_{100%}-values, for the component elements are calculated with the aid of the determined concentrations and with measured intensities I1, I2, . . . , In, or with determined intensities and known concentrations C1, C2, . . . , Cn.

In general, the concentration in a sample is determined through the equation

Cᵢ=kᵢ·Iᵢ·M, (1)

where Cᵢ is the concentration of the element i, kᵢ is the calibration constant, Iᵢ is the measured intensity, and M is the mathematical correction that is used according to the present invention.

When using the mathematical algorithms, the calibration constant is defined by kᵢ=1/I_{100%}, where I_{100%} is the intensity value of the element at a concentration of 100%. Two cases will be described in the present patent application. The first case is the case in which the intensity of a sample is measured and the concentration determined, while the second case is the case in which the intensity has been determined and in which the concentration of the sample is known. Case A can be described using Equation (1) as:

C_{iA}=1/I_{100%A}·I_{iknown}·M, (2)

where C_{iA} is the concentration determined, I_{iknown} is the intensity measured and I_{100%A} is its I_{100%}-value at the concentration determined. In a corresponding manner, Case B can be described as:

C_{iknown}=1/I_{100%B}, ·I_{iB}·M, (3)

where C_{iknown} is the known concentration, I_{iB} is the intensity determined and I_{100%B} is its I_{100%}-value at the determined intensity.

In order subsequently to adjust the calculated I_{100%}-values in Equations (2) and (3), a sample is required with known concentrations and with measured intensities, such as a CRM standard (Certified Reference Material). Equation (1) can be used to describe the relationship for the standard as:

C_{iCRM}=1/I_{100%Just}·I_{iCRM}·M, (4)

where C_{iCRM} is the CRM standard with known concentrations, I_{iCRM} is the CRM standard with known measured intensities and I_{100%Just} is its adjusted I_{100%}-value at the determined intensity.

The adjusted I_{100%}-values can subsequently be derived for the two cases from Equations (2) and (4) and from Equations (3) and (4), respectively. They are calculated as follows:

Case A I_{100%JustA}=(C_{iA}/C_{iCRM}·I_{iCRM}/I_{iknown})·I_{100%A} (5)

Case B I_{100%JustB}=(C_{iknown}/C_{iCRM}·I_{iCRM}/I_{iB})·I_{100%B} (6)

The expected theoretical intensity value at a concentration of 100% for the element E1 is denoted by I_{100%Theor}. This can be considered to be the recorded subset of photons for the element of all photons produced with the X-ray tube used in the spectrometer. An adjustment, calibration, is carried out in step 1, in that the I_{100%Theor}-value for the elements Fe and Si is adjusted such that the concentrations of the samples become 100%.

The said I_{100%}-value is adjusted in the above-mentioned third step by being compared with standards with known concentrations of elements, the intensity of which standards is measured.

The fictive theoretical I_{100%}-values are adjusted in the above-mentioned fourth step—in the case in which the concentration has been determined—with the aid of the calculated fictive I_{100%}-value multiplied by the ratio of the determined concentration to the concentration of the standard and multiplied by the ratio of the known intensity of the standard to the measured intensity, and—in the case in which the intensity has been determined—the calculated fictive I_{100%}-value multiplied by the ratio of the known concentration to the concentration of the standard and multiplied by the ratio of the intensity of the standard to the intensity that has been determined.

A sample with unknown concentrations of the said elements is placed in the above-mentioned fifth step into the spectrometer, and the intensities of the various elements are read out.

According to one preferred embodiment, in the case in which further samples containing the same elements as a sample that has been examined, are to be examined, the said fifth step is repeated without the said first, second, third and fourth steps being repeated.

Thus in practical use, the virtual case is coupled with the given intensities or the determined intensities to the real case through the adjustment of the I_{100%}-values that have been produced against standards with known concentrations, in order to achieve a final calibration.

The description above illustrates how it is possible to carry out calibration for several elements with the aid of a single sample. This is of particular significance for multielement analysis, of which X-ray fluorescence analysis is often an example, and where it may be a case of calibrating maybe 10-50 elements for one method of analysis.

It will readily be realised that the present method saves both time and money when compared with the method according to the above-mentioned patent, and that one of the reasons for this lies in the ability of the method to calculate a background through the use of a single measurement, i.e. the determination of only one point for each element.

The present method can be used also when validating an analysis method. Individual specially produced samples, which are used for calibration, can, with the aid of the method, also be coupled with a validation of an analysis method that has been carried out, and this in itself is valuable since an update of a validation can be placed onto this individual sample. This is particularly valuable in those cases in which problems arise with the hardware of the instrument, as, for example the exchange of the X-ray tube, faults in detectors, a scanner or other more serious faults.

A number of embodiments have been described above. It is, however, obvious that the present method is not strictly bound to the algorithms specified but it would be possible to use other modified algorithms without deviating from the invention as described in the patent claims.

The present invention, therefore, is not to be considered to be limited to the embodiments specified above but it can be varied within the scope specified by the attached patent claims.

1. A method for spectrometry for the investigation of samples, where the sample contains at least two elements, characterised by the combination of a number of steps, namely that a sample with unknown concentrations of the elements is placed in a first step into a spectrometer and the intensities I1, I2, . . . , In of the sample for the various component elements are measured while the concentrations of the sample are determined, or—alternatively—that a sample with known concentrations of the substances C1, C2, . . . , Cn is placed into the spectrometer and the intensities of the sample are determined, in that the fictive theoretical intensity values, the I_{100%}-values, for the component elements are calculated in a second step with the aid of the determined concentrations and the measured intensities I1, I2, . . . , In, or with the aid of the determined intensities and the known concentrations C1, C2, . . . Cn, in that new I_{100%}-values for the corresponding said elements are calculated in a third step with the aid of standards with known concentrations, the intensities of which standards are measured, in that the fictive theoretical I_{100%}-values, for the case in which the concentrations have been determined, are adjusted in a fourth step with the aid of the calculated fictive I_{100%}-values multiplied by the ratio for the concentration determined to the concentration of the standard and multiplied by the ratio for the known intensity of the standard to the measured intensity, and, for the case in which the intensities have been determined, the calculated fictive I_{100%}-value multiplied by the ratio of the known concentration to the concentration of the standard and multiplied by the ratio for the intensity of the standard to the determined intensity, and in that a sample with unknown concentrations of the said elements is placed in a fifth step into the spectrometer and the intensities of the various elements are read off.

2. A method according to claim 1, characterised in that the calculation takes place according to the second step through the use of a correlation between the concentration of an element and the intensity that the said concentration gives rise to in the spectrometer that is used.

3. A method according to claim 2, characterised in that the calculation in the said second step, in which the said known concentrations C1, C2, . . . , Cn for the component elements are related to the measured intensities I1, I2, . . . , In such that a fictive intensity for a 100% pure element for each of the elements is calculated, takes place using algorithms described in the article “Application of J. E. Fernandez algorithms in the evaluation of X-ray intensities measured on fused glass discs for a set of international standards and a proposed calibration procedure”, J Malmqvist; X-RAY SPECTROMETRY; X-Ray Spectrom 2001; 30:83-92.

4. A method according to claim 1, characterised in that in the case in which further samples containing the same elements as a sample that has been examined are to be examined, the said fifth step is repeated without the said first, second and third steps being repeated.

5. A method according to claim 2, characterised in that in the case in which further samples containing the same elements as a sample that has been examined are to be examined, the said fifth step is repeated without the said first, second and third steps being repeated.

6. A method according to claim 3, characterised in that in the case in which further samples containing the same elements as a sample that has been examined are to be examined, the said fifth step is repeated without the said first, second and third steps being repeated.
